(19) United States
(12) Patent Application Publication
(10) Pub. No.: US 2025/0301342 A1
(43) Pub. Date: Sep. 25, 2025

(54) AI/ML Model/Functionality Adaptation for RRM Enhancements

(71) Applicant: Apple Inc., Cupertino, CA (US)

(72) Inventors: Konstantinos SARRIGEORGIDIS, Los Gatos, CA (US); Jie CUI, San Jose, CA (US); Manasa RAGHAVAN, Sunnyvale, CA (US); Xiang CHEN, Palo Alto, CA (US); Yang TANG, San Jose, CA (US)

(21) Appl. No.: 19/084,082

(22) Filed: Mar. 19, 2025

Related U.S. Application Data
(60) Provisional application No. 63/567,036, filed on Mar. 19, 2024.

(51) Int. Cl. H04W 24/02; H04B 7/06; H04L 5/00

(52) U.S. Cl. CPC H04W 24/02; H04B 7/06952; H04L 5/0098

(57) ABSTRACT

An apparatus configured to generate, for transmission to a serving cell, capability information comprising a list of models employing artificial intelligence (AI) or machine learning (ML) for beam management that are currently stored by a user equipment (UE), wherein each model is associated with first conditions for which the model is valid, process, based on signals received from the serving cell, assistance information to adapt beam measurements for a first model stored by the UE to be used under second conditions different from the first conditions for which the first model is valid and adapt the beam measurements based on the assistance information to generate input data for the first model.

### PRIORITY/INCORPORATION BY REFERENCE

This application claims priority to U.S. Provisional Application Ser. No. 63/567,036 filed Mar. 19, 2024 and entitled, “AI/ML Model/Functionality Adaptation for RRM Enhancements,” the entirety of which is incorporated by reference herein.

### BACKGROUND

Artificial intelligence (AI) and/or machine learning (ML) processes, e.g., deep learning neural networks, convolutional neural networks, etc., may be used to augment operations for the air interface in a cellular radio access network (RAN), e.g., 5G New Radio (NR) RAN, 6G RAN, etc. The use cases of AI/ML for the air interface include radio resource management (RRM) enhancements such as channel state information (CSI) feedback enhancements, e.g., overhead reduction, improved accuracy, and prediction, and beam management enhancements, e.g., beam prediction in time and/or spatial domain for overhead and latency reduction, beam selection accuracy improvement.

Generalization refers to the ability of an AI/ML model to adapt properly to previously unseen data. Generalization and post-deployment validation of AI/ML functionality in air interface implementations currently poses a large challenge. The generalization performance of a given AI/ML model depends heavily on the configuration and parameter settings for dataset generation used for training the model. In one example, an AI/ML model trained with a dataset comprising beams transmitted with a particular codebook may have difficulties inferencing with beams transmitted with a different codebook. In another example, changing radio conditions may affect the performance of the AI/ML model. If the configured AI/ML functionality/model has been trained with a dataset representing a certain radio condition environment, then this AI/ML functionality/model may experience degraded performance if different channel conditions are met in the field.

### SUMMARY

Some example embodiments are related to an apparatus having processing circuitry configured to generate, for transmission to a serving cell, capability information comprising a list of models employing artificial intelligence (AI) or machine learning (ML) for beam management that are currently stored by a user equipment (UE), wherein each model is associated with first conditions for which the model is valid, process, based on signals received from the serving cell, assistance information to adapt beam measurements for a first model stored by the UE to be used under second conditions different from the first conditions for which the first model is valid and adapt the beam measurements based on the assistance information to generate input data for the first model.

Other example embodiments are related to an apparatus having processing circuitry configured to process, based on signals received from a user equipment (UE), capability information comprising a list of models employing artificial intelligence (AI) or machine learning (ML) for beam management that are currently stored by the UE, wherein each model is associated with conditions for which the model is valid, process, based on signals received from a neighbor cell, transmit (Tx) beam information for a beam sweeping process of the neighbor cell, determine, for a first model stored by the UE as indicated by the capability information, assistance information to adapt beam measurements for the first model to be used for the beam sweeping process of the neighbor cell, the beam sweeping process of the neighbor cell being different from a beam sweeping process for which the first model is valid and generate, for transmission to the UE, a message comprising the assistance information

Still further example embodiments are related to an apparatus having processing circuitry configured to process, based on signals received from a user equipment (UE), capability information comprising a list of models employing artificial intelligence (AI) or machine learning (ML) for beam management that are currently stored by the UE, wherein each model is associated with conditions for which the model is valid, process, based on signals received from a neighbor cell, transmit (Tx) beam information for a beam sweeping process of the neighbor cell and generate, for transmission to the neighbor cell, an instruction for the neighbor cell to transmit new training data to one of a remote server to trigger the remote server to train a new model to be used for the beam sweeping process of the neighbor cell, the beam sweeping process of the neighbor cell being different from a beam sweeping process for which any of the models currently stored by the UE are valid or the UE to trigger the UE to retrain a first model to be used for the beam sweeping process of the neighbor cell.

Additional example embodiments are related to an apparatus having processing circuitry configured to generate, for transmission to a serving cell, capability information comprising a list of models employing artificial intelligence (AI) or machine learning (ML) for beam management that are currently stored by a user equipment (UE), wherein each model is associated with first conditions for which the model is valid, process, based on signals received from the serving cell, an instruction to refrain from using any of the AI/ML models currently stored by the UE, process one of a firmware over the air (FOTA) update including a new model to be used under second conditions, different from the first conditions, for which one or more of the models currently stored by the UE are valid or new training data to retrain a first model to be used under the second conditions, and generate, for transmission to the serving cell, updated capability information for the new model or the first model after retraining.

### BRIEF DESCRIPTION OF THE DRAWINGS

FIG. 1 shows a diagram of a scenario in which an AI/ML model stored by a user equipment (UE) suitable for measuring transmit (Tx) beams of a serving cell is not suitable for measuring Tx beams of a neighbor cell according to one example.

FIG. 2 shows a diagram for adapting an AI/ML model in view of assistance information according to various example embodiments.

FIG. 3 shows a diagram for providing assistance information including a mapping of a beam pattern of a serving cell to a beam pattern of a neighbor cell according to various example embodiments.

FIG. 4 shows a diagram for generating a new AI/ML model for a UE according to various example embodiments.

FIG. 5 shows a diagram for retraining an AI/ML model for a UE according to various example embodiments.

FIG. 6 shows an example network arrangement according to various example embodiments.

FIG. 7 shows an example user equipment (UE) according to various example embodiments.

FIG. 8 shows an example base station according to various example embodiments.

### DETAILED DESCRIPTION

The example embodiments may be further understood with reference to the following description and the related appended drawings, wherein like elements are provided with the same reference numerals. The example embodiments relate to a framework for adapting artificial intelligence (AI) and/or machine learning (ML) models deployed by a user equipment (UE) in scenarios where the AI/ML model(s) currently stored by the UE may have difficulties generalizing in a current radio environment. In some aspects of these example embodiments, a UE may receive assistance information from a serving cell to enhance the generalization capacity of a currently stored AI/ML model. In other aspects of these example embodiments, when the inference of a currently stored AI/ML model cannot be aided by assistance information, the UE may receive a new AI/ML model trained in a new offline training procedure. In still other aspects of these example embodiments, when the inference of a currently stored AI/ML model cannot be aided by assistance information, the UE may receive new training data to fine tune a currently stored AI/ML model in an online training (or reinforcement learning) process.

There is no requirement in the example embodiments that the currently stored AI/ML models are experiencing any specific difficulties or any difficulties at all. Rather, the example embodiments may be used to adapt any currently stored AI/ML models regardless of how the currently stored AI/ML models are operating.

In each of these aspects, a current serving cell for the UE may receive capability information from the UE indicating which AI/ML models the UE currently supports, e.g., which AI/ML models are currently stored at the UE. If the UE is to perform neighbor cell measurements in a new cell having a different propagation environment and/or different beam configuration/parameters than the serving cell, the serving cell may assess whether any of the AI/ML models the UE currently supports may be used for the neighbor cell measurements. The serving cell may receive information from the neighbor cell regarding the transmit (Tx) beam pattern used by the neighbor cell. If the UE currently supports an AI/ML model for the neighbor cell Tx beam pattern, the serving cell may instruct the UE to use this AI/ML model. If the UE does not currently support any AI/ML models for the neighbor cell Tx beam pattern, the serving cell may determine whether assistance information may allow the UE to use a currently supported AI/ML model. If no assistance information will allow the UE to use a currently supported AI/ML model, then the serving cell may instruct the neighbor cell to provide new training data. The new training data may be provided directly to the UE in an online training process for retraining a currently stored AI/ML model or may be provided to a server, e.g., a non-3GPP server, so that the server may train a new model and provide the new model to the UE, e.g., in a firmware over the air (FOTA) update.

The example embodiments are described with regard to a user equipment (UE). However, reference to a UE is merely provided for illustrative purposes. The example embodiments may be utilized with any electronic component that may establish a connection to a network and is configured with the hardware, software, and/or firmware to exchange signaling and/or data with the network. Therefore, the UE as described herein is used to represent any electronic component.

The example embodiments are also described with reference to a 5G New Radio (NR) network. However, reference to a 5G NR network is merely provided for illustrative purposes. The example embodiments may be utilized with any network implementing AI/ML functionalities similar to those described herein, e.g., 5G-Advanced network, 6G network, etc. Therefore, the 5G NR network as described herein may represent any type of network implementing AI/ML functionalities similar to the 5G NR network.

The example embodiments are also described with regard to AI/ML-based radio resource management (RRM), in particular, AI/ML-based beam management (BM). Beam management generally refers to a set of procedures configured to acquire and maintain a beam between a transmission and reception point (TRP) and the UE. The terms P1, P2 and P3 refer to processes for beam management during initial access and while in the CONNECTED state. In the P1 process, the base station (e.g., qNB) performs Tx beam sweeping of synchronization signal blocks (SSBs), typically from a set of different beams, and the UE performs reception (Rx) wide beam sweeping from a set of different beams. The UE measures the signal strength (e.g., Reference Signal Received Power (RSRP)) of each of the SSBs of the received beams and selects the best beam to report to the gNB. In the P2 process, the gNB performs beam refinement by performing Tx beam sweeping of Channel State Information-Reference Signal (CSI-RS), possibly from a smaller set of beams than the P1 process, and the UE performs Rx wide beam sweeping from a set of different beams. The P2 Tx beam sweeping may be narrower than that of P1. The UE measures the signal strength (e.g., RSRP) of the CSI-RS of the received beams and selects the best beam to report to the qNB. In the P3 process the gNB (TRP) repeatedly transmits the same beam and the UE refines its Rx beam.

An AI/ML model may be employed for beam prediction to reduce overhead/latency and improve beam selection. The AI/ML model may be employed for beam prediction in the time domain and/or the spatial domain. In both cases, a set of downlink beams may be measured and used as input to the AI/ML model to predict the best beam within another set of downlink beams. In some example embodiments, the measured parameter/quantity may be L1 RSRP. However, the example embodiments are not limited to this parameter. The measured set of downlink beams may be referred to as “Set B” and the predicted set of downlink beams may be referred to as “Set A.” Set B may be a subset of Set A, or Set B may be different from Set A. In one example, Set B may comprise 10 beams and Set A may comprise 32 beams.

The example embodiments are also described with reference to an AI/ML framework for the air interface. AI/ML model life cycle management (LCM) refers to the development, deployment and management of an AI/ML model. There are two main categories of AI/ML LCM in the Third Generation Partnership (3GPP) Technical Specification (TSs), in particular, functionality-based LCM and model ID-based LCM. In functionality-based LCM, a functionality refers to a feature enabled by a configuration. For both functionality-based and model ID-based LCM, the UE may store the AI/ML model (with the associated model ID or functionality/configuration) and exchange this information with the network as capability information. Each AI/ML model ID or AI/ML functionality/configuration may be associated with conditions such that the model is valid only for a particular network vendor, cell site, and/or frequency band. Generally, the number of AI/ML models stored by the UE may be kept low in order to reduce the complexity, model storage and AI/ML model transfer requirements. AI/ML models may be transferred to the UE through some collaboration with the network.

For AI/ML based beam management solutions, generalization poses one of the main challenges. Generalization issues may include the following aspects.

In a first generalization issue, changing radio conditions may affect the performance of the AI/ML model. If the configured AI/ML functionality/model has been trained with a dataset representing a certain radio condition environment, then this AI/ML functionality/model may experience degraded performance if different channel conditions are met in the field.

In a second generalization issue, changing configurations/parameters settings may affect the performance of the AI/ML model. The impact of generalization on the performance of various AI/ML use cases depends heavily on the configuration and parameter settings used for dataset generation for the training. For example, for the AI/ML beam management use case, configurations should cover different beam sets/codebooks used, number of wide/narrow beams, grid of beam configuration, etc. Similarly, parameters settings may include different sweeping frequency of the beams, the power settings, etc.

Thus, an AI/ML model trained with a database corresponding to particular reference radio conditions and reference configuration/parameters may have degraded performance in view of changing reference radio conditions and configurations.

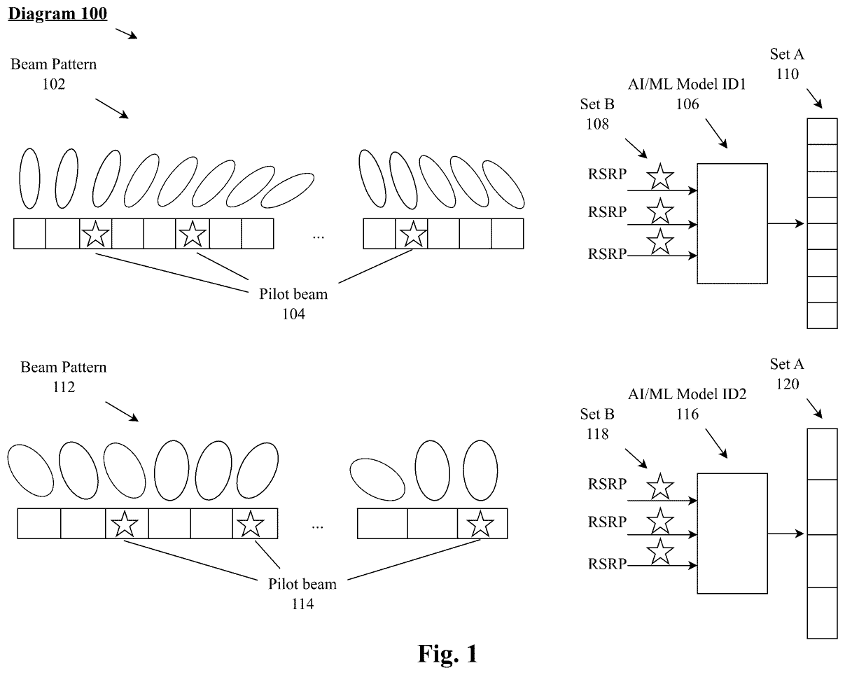

FIG. 1 shows a diagram 100 of a scenario in which an AI/ML model stored by a user equipment (UE) suitable for measuring transmit (Tx) beams of a serving cell is not suitable for measuring Tx beams of a neighbor cell according to one example. The diagram 100 includes a beam pattern 102 for a serving cell. In this example, the beam pattern 102 corresponds to a synchronization signal block (SSB) beam pattern and includes 64 beams. The diagram 100 shows an example spatial pattern for beams 1-64.

In this example, a first AI/ML model 106, e.g., AI/ML Model ID1, is associated with a certain configuration and/or parameters. In this example, the first AI/ML model 106 is suitable for measuring the beams of the beam pattern 102. The pilot beams 104 of the beam pattern 102 make up Set B 108. The RSRP is measured for these beams and these RSRP values are input into the first AI/ML model 106. The AI/ML model 106 predicts Set A 110.

The diagram 100 further includes a beam pattern 112 for a neighbor cell. The beam pattern 112 corresponds to a SSB beam pattern. However, the beam pattern 112 for the neighbor cell includes a different number of SSB, e.g., 16 or 32 beams. Further, the beams of the beam pattern 112 comprise a different shape than the beams of the beam pattern 102. In this example, a second AI/ML model 116, e.g., AI/ML Model ID2, is associated with a certain configuration and/or parameters. In this example, the second AI/ML model 116 is suitable for measuring the beams of the beam pattern 112. The pilot beams 114 of the beam pattern 112 make up Set B 118. The RSRP is measured for these beams and these RSRP values are input into the second AI/ML model 116. The second AI/ML model 116 predicts Set A 120.

As shown in the example diagram 100 above, the beam patterns between a serving cell and neighbor cell may be different. A UE may have the first AI/ML model 106 stored and may enter AI/ML mode for the serving cell. However, the UE may not have the second AI/ML model 116 stored. Accordingly, an AI/ML model different from the stored AI/ML models may be needed for the different Tx beam pattern.

In some aspects of these example embodiments, assistance information may be provided to the UE so that the UE may adapt the AI/ML-assisted beam measurements for a given stored AI/ML model so that the currently stored AI/ML model may be used for a different Tx beam pattern. In one example scenario, the UE may have an AI/ML model suitable for use with a serving cell but not suitable for use with a neighbor cell. In these embodiments, the Tx beam patterns for the serving cell and the neighbor cell may share enough similarities such that the same AI/ML model may be adapted for use with the neighbor cell.

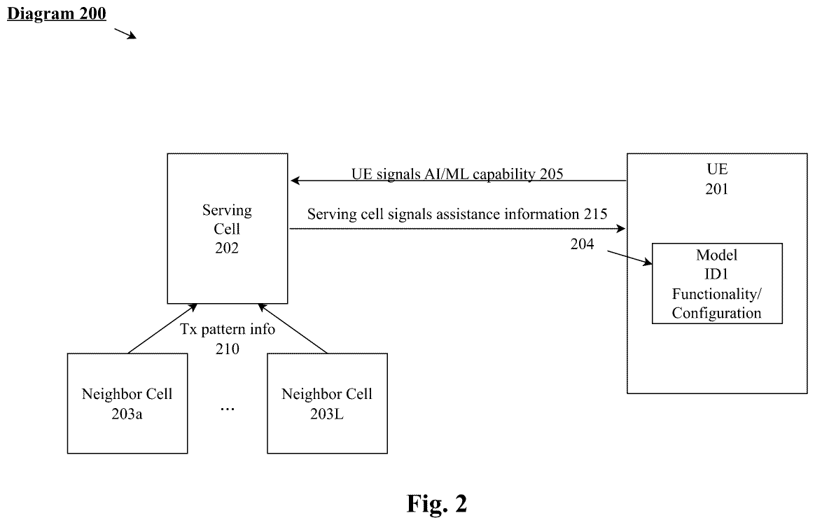

FIG. 2 shows a diagram 200 for adapting an AI/ML model in view of assistance information according to various example embodiments. The diagram 200 includes a UE 201, a serving cell 202 and multiple neighbor cells 203, e.g., L neighbor cells 203a-L. Any number of neighbor cells 203 may be configured for the UE 201 including only a single neighbor cell. In this example, the UE 201 has a first AI/ML model 204 stored, e.g., Model ID1 or a first functionality/configuration. The UE 201 may have additional AI/ML models stored.

In 205, the UE 201 signals its AI/ML-related capabilities to the serving cell 202. If a model-ID based LCM framework is used, the UE 201 may signal the Model ID numbers it supports. If a functionality-based LCM framework is used, the UE 201 may signal the functionality/configuration it supports. The Model ID or functionality/configuration may have a number of associated conditions, e.g., vendor, cell site, frequency, etc.

For performing measurements in a new cell comprising, for example, a different grid of beams, different beam shapes, a different frequency, etc., the serving cell 202 may assess whether any of the AI/ML models reported by the UE 201 may be used to match the new radio propagation environment and configuration/parameters. In 210, the serving cell 202 receives Tx beam pattern information from the neighbor cell(s) 203. The serving cell 202 may request this information from the neighbor cell(s) 203.

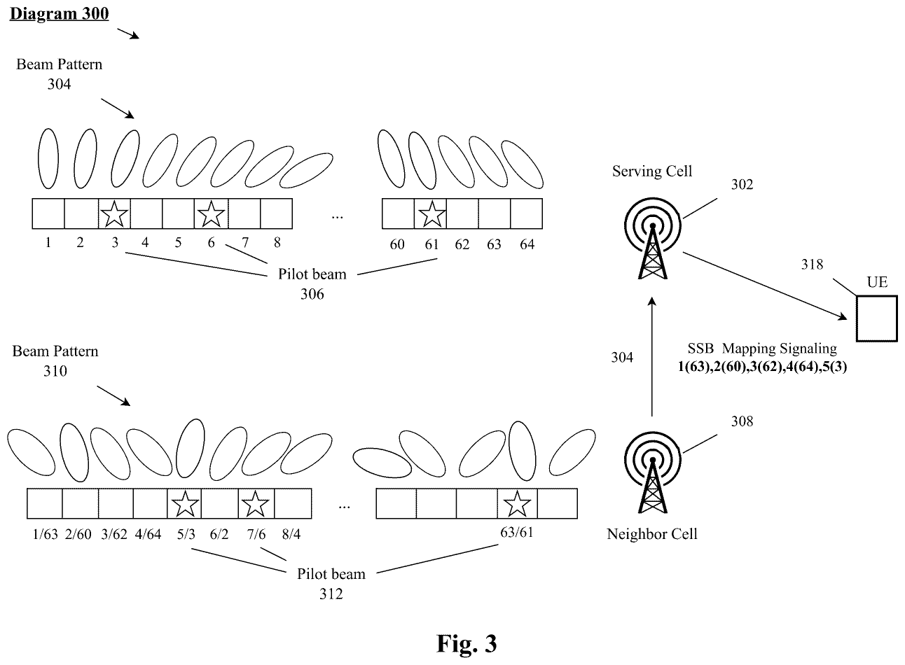

If the Tx beam pattern information from the neighbor cell(s) 203 has sufficient similarities to a Tx pattern suitable for inferencing with a AI/ML model stored by the UE 201, then the serving cell 203 may determine assistance information to provide to the UE 201. Some examples of beam pattern information for serving cell and neighbor cell(s) that are sufficiently similar are described below. One example of such assistance information for sufficiently similar beam patterns is described below in FIG. 3. However, the assistance information may take many different forms depending on, e.g., the beam set/codebook, beam width, grid of beam configuration, sweeping frequency, power setting, etc., of the neighbor cell relative to the beam set/codebook, beam width, etc. used to train the AI/ML model stored by the UE 201.

In 215, the serving cell 202 provides the assistance information to the UE 201 so that the UE 201 may use the stored AI/ML model for inferencing the neighbor beams. With the assistance information, the UE 201 may adapt the channel measurements performed on the neighbor cell 203 as input to the stored AI/ML model.

The AI/ML model may be adapted based on assistance information in certain scenarios, e.g., when the configuration/parameters for the beam set to be measured shares certain similarities with the configuration/parameters for a stored AI/ML model.

FIG. 3 shows a diagram 300 for providing assistance information including a mapping of a beam pattern of a serving cell to a beam pattern of a neighbor cell according to various example embodiments. The diagram 300 includes a beam pattern 304 for a serving cell 302. In this example, the beam pattern 304 corresponds to a synchronization signal block (SSB) beam pattern. The beam pattern 304 of the SSB includes 64 beams. The diagram 300 shows an example spatial pattern for beams 1-64 of the serving cell 302.

In this example, a neighbor cell 308 transmits a beam pattern 310 that shares a same Tx codebook pattern as the serving cell 302, however, with the Tx beams shuffled relative to the serving cell 302. In 314, the neighbor cell 308 may provide its Tx beam pattern 310 to the serving cell 302 so that the serving cell 302 may determine a mapping between the SSB index of the neighbor cell 308 to the SSB index of the serving cell 302.

The serving cell 302 determines the mapping, e.g., SSB index 1, 2, 3, 4, 5 of the neighbor cell 308 spatially corresponds to SSB index 63, 60, 62, 64, 3 of the serving cell 302. In this example, the pilot beams 306 of the serving cell 302 correspond to SSB indexes 3, 6, 61. These SSB indexes of the serving cell 302 “align” with SSB indexes 5,7, 63 of the neighbor cell 308, as shown in the beam pattern 310. Thus, pilot beams 312 may comprise Set B for inferencing using the currently stored AI/ML model.

Thus, for an AI/ML model suitable for beam management on the serving cell 302, the mapping between the neighbor cell 308 and the serving cell 302 may be provided to the UE 318. In 316, the SSB mapping is signaled to the UE 318 as assistance information so that the UE 318 may determine which SSB indexes of the neighbor cell 308 to use as input to the AI/ML model.

As described above, this is only one example of potential assistance information that may be provided to the UE. Other examples of assistance information may include, for example, a set A and set B configuration, a number of set A beams, a number of set B beams, a pattern of set B (e.g., fixed, random or pre-configured), a number of history measurements for beam management (BM) prediction, a number of future time predictions for BM prediction, a shape of Tx beams (e.g., 3 dB bandwidth (BW), pointing angles, beam shape, etc.) and a deployment scenario (e.g., 3D-urban micro (UMi), 3D-urban macro (UMa), indoor scenario, etc.). These are only examples of assistance information; other types of assistance information may also be provided in addition to or exclusive of the provided examples.

In other aspects of these example embodiments, if assistance information cannot be used to aid the inference of a currently stored AI/ML model, a serving cell may initiate the creation of a new AI/ML model. The serving cell may initiate a new offline training procedure to be performed at a remote server. For example, the server could be located outside the 3GPP domain to reduce air interface resources for training. The serving cell may instruct a neighbor cell to provide new training data to the server so that the server may train the new model and provide the new model to the UE, e.g., in a firmware over the air (FOTA) update. The UE, upon receiving the new model, may update its capability information to the serving cell. The serving cell may then trigger the UE to use the new model for beam management for the neighbor cell.

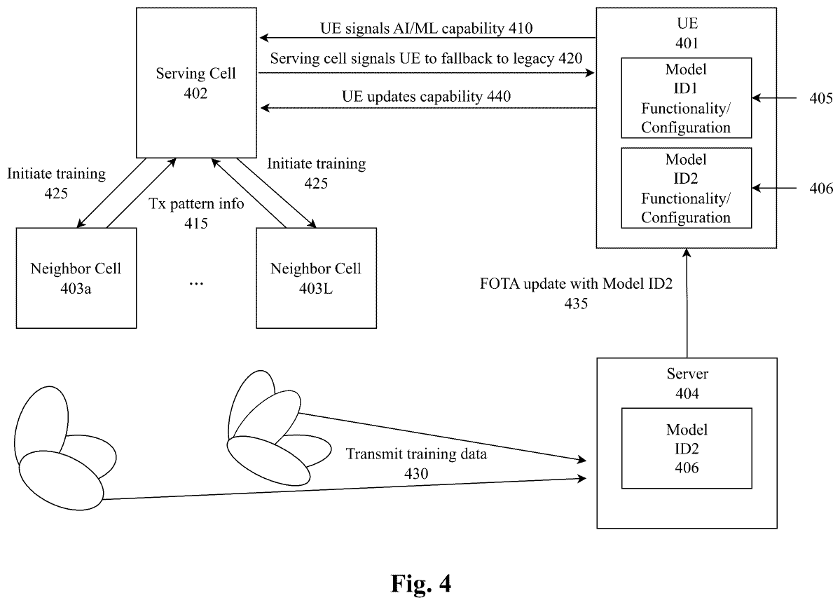

FIG. 4 shows a diagram 400 for generating a new AI/ML model for a UE according to various example embodiments. The diagram 400 includes a UE 401, a serving cell 402, multiple neighbor cells 403, e.g., L neighbor cells 403a-L, and a remote server 404. In this example, the UE 401 has a first AI/ML model 405 stored, e.g., Model ID1 or a first functionality/configuration. The remote server 404 may be a non-3GPP server configured for training new AI/ML models.

In 410, the UE 401 signals its AI/ML-related capabilities to the serving cell 402, similar to 205 of FIG. 2. For performing measurements in a new cell comprising, e.g., a different grid of beams, a different frequency, etc., the serving cell 402 may assess whether any of the AI/ML models reported by the UE 401 may be used to match the new radio propagation environment and configuration/parameters. In 415, the serving cell 402 receives Tx beam pattern information from the neighbor cell(s) 403.

In this example, the serving cell 403 determines that the Tx beam pattern information from the neighbor cell(s) 403 do not have sufficient similarities to a Tx pattern suitable for inferencing with a AI/ML model stored by the UE 401 such that assistance information may not aid the UE 401 in using a stored model. Accordingly, the serving cell 403 determines that a new model should be created for the UE 401.

In 420, the serving cell 403 signals the UE 401 to fallback to legacy beam management processes since none of the AI/ML models stored by the UE 401 are suitable for inferencing the neighbor cell measurements. In 425, the serving cell 402 instructs the neighbor cell(s) 403 to initiate training of a new model.

In 430, the neighbor cells 403 transmit training data to the server 404. The training data comprises the neighbor cell transmit beam pattern. The training data may be sent over a non-3GPP air interface or any other manner of sending the training data. The server 404 trains the new model 406, referred to as Model ID2 in this example.

In 435, the server 404 transmits the new model 406 to the UE 401 in a FOTA update. The FOTA update includes the model ID, model information, deployment and functional association, etc. The UE 401 stores the new model 406. In 440, the UE 401 transmits an updated capability report to the serving cell 402. The serving cell 402 may now trigger the UE 401 to use the new model 406.

The process described above may be repeated for any number of neighbor cells. However, if the UE receives multiple new models, it may impose a complexity/storage burden on the UE. Accordingly, in some embodiments, the UE may refresh a list of supported AI/ML models after some timer duration. For example, the UE may keep the AI/ML models of the most recently visited neighbor cells and discard any remaining AI/ML models.

In still other aspects of these example embodiments, if assistance information cannot be used to aid the inference of a currently stored AI/ML model, a serving cell may initiate an online training process so that the UE may retrain a currently stored AI/ML model for use with a neighbor cell having different Tx beam sweeping characteristics. The serving cell may instruct a neighbor cell to provide new training data to the UE so that the UE may retrain, e.g., fine-tune, a currently stored model. The UE, upon retraining the model, may update its capability information to the serving cell. The serving cell may then trigger the UE to use the retrained model for beam management for the neighbor cell.

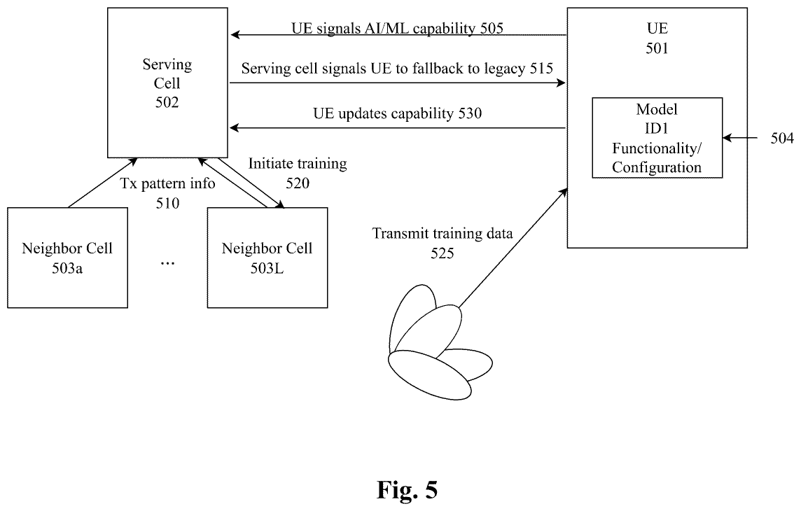

FIG. 5 shows a diagram 500 for retraining an AI/ML model for a UE according to various example embodiments. The diagram 500 includes a UE 501, a serving cell 502, and multiple neighbor cells 503, e.g., L neighbor cells 503a-L. In this example, the UE 501 has a first AI/ML model 504 stored, e.g., Model ID1 or a first functionality/configuration.

In 505, the UE 501 signals its AI/ML-related capabilities to the serving cell 502, similar to the preceding embodiments. For performing measurements in a new cell comprising, e.g., a different grid of beams, a different frequency, etc., the serving cell 502 may assess whether any of the AI/ML models reported by the UE may be used to match the new radio propagation environment and configuration/parameters. In 510, the serving cell 502 receives Tx beam pattern information from the neighbor cell(s) 503.

In this example, the serving cell 502 determines that the Tx beam pattern information from the neighbor cell(s) 503 may not have sufficient similarities to a Tx pattern suitable for inferencing with a AI/ML model stored by the UE 501 such that assistance information will not aid the UE 501 in using a stored model. Accordingly, the serving cell 502 determines that a currently stored model should be retrained.

In 515, the serving cell 502 signals the UE 501 to fallback to legacy beam management processes since none of the AI/ML models stored by the UE 501 are suitable for inferencing the neighbor cell measurements. In 520, the serving cell 502 instructs the neighbor cells 503 to transmit new training data to the UE 501.

In 525, the neighbor cells 503 transmit training data to the UE 501. The training data comprises the neighbor cell transmit beam pattern. The UE 501 retrains the AI/ML model. In 530, the UE 501 transmits an updated capability report to the serving cell 502. The serving cell 502 may now trigger the UE 501 to use the retrained model 504.

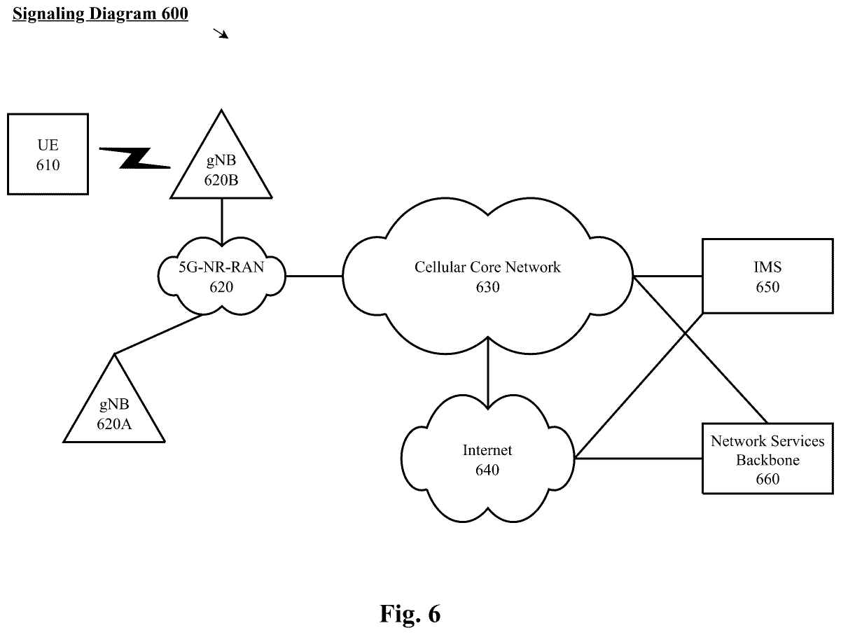

FIG. 6 shows an example network arrangement 600 according to various example embodiments. The example network arrangement 600 includes a UE 610. The UE 610 may be any type of electronic component that is configured to communicate via a network, e.g., mobile phones, tablet computers, desktop computers, smartphones, embedded devices, wearables, Internet of Things (IoT) devices, etc. An actual network arrangement may include any number of UEs being used by any number of users. Thus, the example of one UE 610 is merely provided for illustrative purposes.

The UE 610 may be configured to communicate with one or more networks. In the example of the network arrangement 600, the network with which the UE 610 may wirelessly communicate is a 5G NR radio access network (RAN) 620. However, the UE 610 may also communicate with other types of networks (e.g., 5G cloud RAN, a next generation RAN (NG-RAN), a legacy cellular network, etc.) and the UE 610 may also communicate with networks over a wired connection. With regard to the example embodiments, the UE 610 may establish a connection with the 5G NR RAN 620. Therefore, the UE 610 may have a 5G NR chipset to communicate with the NR RAN 620.

The 5G NR RAN 620 may be portions of a cellular network that may be deployed by a network carrier (e.g., Verizon, AT&T, T-Mobile, etc.). The RAN 620 may include cells or base stations that are configured to send and receive traffic from UEs that are equipped with the appropriate cellular chip set. In this example, the 5G NR RAN 620 includes the gNB 620A and the gNB 620B. However, reference to a gNB is merely provided for illustrative purposes, any appropriate base station or cell may be deployed (e.g., Node Bs, eNodeBs, HeNBs, eNBs, gNBs, gNodeBs, macrocells, microcells, small cells, femtocells, etc.).

Any association procedure may be performed for the UE 610 to connect to the 5G NR RAN 620. For example, as discussed above, the 5G NR RAN 620 may be associated with a particular network carrier where the UE 610 and/or the user thereof has a contract and credential information (e.g., stored on a SIM card). Upon detecting the presence of the 5G NR RAN 620, the UE 610 may transmit the corresponding credential information to associate with the 5G NR RAN 620. More specifically, the UE 610 may associate with a specific cell (e.g., gNB 620A).

The network arrangement 600 also includes a cellular core network 630, the Internet 640, an IP Multimedia Subsystem (IMS) 650, and a network services backbone 660. The cellular core network 630 manages the traffic that flows between the cellular network and the Internet 640. The IMS 650 may be generally described as an architecture for delivering multimedia services to the UE 610 using the IP protocol. The IMS 650 may communicate with the cellular core network 630 and the Internet 640 to provide the multimedia services to the UE 610. The network services backbone 660 is in communication either directly or indirectly with the Internet 640 and the cellular core network 630. The network services backbone 660 may be generally described as a set of components (e.g., servers, network storage arrangements, etc.) that implement a suite of services that may be used to extend the functionalities of the UE 610 in communication with the various networks.

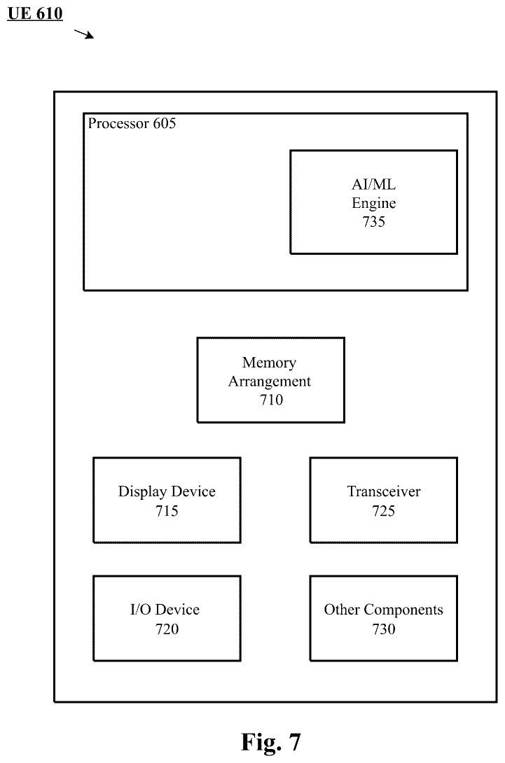

FIG. 7 shows an example UE 610 according to various example embodiments. The UE 610 will be described with regard to the network arrangement 600 of FIG. 6. The UE 610 may represent any electronic device and may include a processor 705, a memory arrangement 710, a display device 715, an input/output (I/O) device 720, a transceiver 725, and other components 730. The other components 730 may include, for example, an audio input device, an audio output device, a battery that provides a limited power supply, a data acquisition device, ports to electrically connect the UE 610 to other electronic devices, sensors to detect conditions of the UE 610, etc.

The processor 705 may be configured to execute a plurality of engines for the UE 610. For example, the engines may include an AI/ML engine 735 for performing operations related to deploying an AI/ML model for beam management, as described in detail above.

The above referenced engines being an application (e.g., a program) executed by the processor 705 is only an example. The functionality associated with the engines may also be represented as a separate incorporated component of the UE 610 or may be a modular component coupled to the UE 610, e.g., an integrated circuit with or without firmware. For example, the integrated circuit may include input circuitry to receive signals and processing circuitry to process the signals and other information. The engines may also be embodied as one application or separate applications. In addition, in some UEs, the functionality described for the processor 705 is split among two or more processors such as a baseband processor and an applications processor. The example embodiments may be implemented in any of these or other configurations of a UE.

In some examples, transmit beam pattern inputs or other beam related inputs may be fed to AI/ML engine 735. The AI/ML engine 735 may include one or more learning-based and/or non-learning-based models for perceiving, synthesizing, and inferring information. Persons skilled in the art will appreciate that the AI/ML engine 735 can include any suitable number of processes to update beam models based on transmit beam pattern inputs or other beam related inputs.

Persons of ordinary skill in the art will appreciate that AI/ML engine 735 can include any suitable machine learning models that are well-known or widely available such as regression techniques, classification techniques, neural networks, and deep learning networks. In instances where [AI/ML engine 735 comprises a machine-learning based model, [AI/ML engine 735 can be trained to update beam models based on transmit beam pattern inputs or other beam related inputs using one or more well-known or widely available training techniques such as supervised learning, semi-supervised learning, unsupervised learning, and/or reinforcement learning techniques.

The memory arrangement 710 may be a hardware component configured to store data related to operations performed by the UE 610. The display device 715 may be a hardware component configured to show data to a user while the I/O device 720 may be a hardware component that enables the user to enter inputs. The display device 715 and the I/O device 720 may be separate components or integrated together such as a touchscreen.

The transceiver 725 may be a hardware component configured to establish a connection with the 5G NR-RAN 620, an LTE-RAN (not pictured), a legacy RAN (not pictured), a WLAN (not pictured), etc. Accordingly, the transceiver 725 may operate on a variety of different frequencies or channels (e.g., set of consecutive frequencies). The transceiver 725 includes circuitry configured to transmit and/or receive signals (e.g., control signals, data signals). Such signals may be encoded with information implementing any one of the methods described herein. The processor 705 may be operably coupled to the transceiver 725 and configured to receive from and/or transmit signals to the transceiver 725. The processor 705 may be configured to encode and/or decode signals (e.g., signaling from a base station of a network) for implementing any one of the methods described herein.

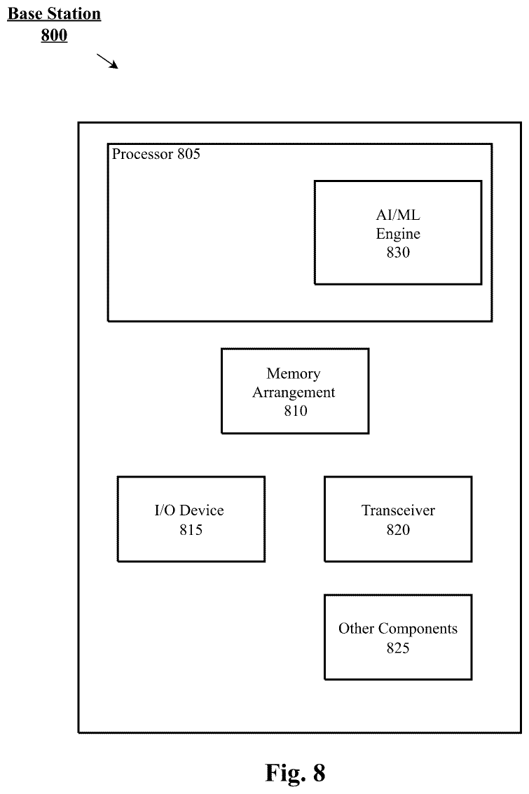

FIG. 8 shows an example base station 800 according to various example embodiments. The base station 800 may represent the gNB 620A, the gNB 620B or any other access node through which the UE 610 may establish a connection and manage network operations.

The base station 800 may include a processor 805, a memory arrangement 810, an input/output (I/O) device 815, a transceiver 820, and other components 825. The other components 825 may include, for example, an audio input device, an audio output device, a battery, a data acquisition device, ports to electrically connect the base station 800 to other electronic devices and/or power sources, etc.

The processor 805 may be configured to execute a plurality of engines for the UE 610. For example, the engines may include an AI/ML engine 830 for deploying an AI/ML model for beam management, as described in detail above.

The memory arrangement 810 may be a hardware component configured to store data related to operations performed by the base station 800. The I/O device 815 may be a hardware component or ports that enable a user to interact with the base station 800.

The transceiver 820 may be a hardware component configured to exchange data with the UE 610 and any other UE in the network arrangement 600. The transceiver 820 may operate on a variety of different frequencies or channels (e.g., set of consecutive frequencies). The transceiver 820 includes circuitry configured to transmit and/or receive signals (e.g., control signals, data signals). Such signals may be encoded with information implementing any one of the methods described herein. The processor 805 may be operably coupled to the transceiver 820 and configured to receive from and/or transmit signals to the transceiver 820. The processor 805 may be configured to encode and/or decode signals (e.g., signaling from a UE) for implementing any one of the methods described herein.

Those skilled in the art will understand that the above-described example embodiments may be implemented in any suitable software or hardware configuration or combination thereof. An example hardware platform for implementing the example embodiments may include, for example, an Intel x86 based platform with compatible operating system, a Windows OS, a Mac platform and MAC OS, a mobile device having an operating system such as iOS, Android, etc. The example embodiments of the above described method may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

Some example embodiments described herein can include use of learning and/or non-learning-based process(es). The use can include collecting, pre-processing, encoding, labeling, organizing, analyzing, recommending and/or generating data. Entities that collect, share, and/or otherwise utilize user data should provide transparency and/or obtain user consent when collecting such data. The present disclosure recognizes that the use of the data in the AI/ML processes can be used to benefit users.

For example, the data can be used to train models that can be deployed to improve performance, accuracy, and/or functionality of applications and/or services. Accordingly, the use of the data enables the AI/ML processes to adapt and/or optimize operations to provide more personalized, efficient, and/or enhanced user experiences. Such adaptation and/or optimization can include tailoring content, recommendations, and/or interactions to individual users, as well as streamlining processes, and/or enabling more intuitive interfaces. Further beneficial uses of the data in the AI/ML processes are also contemplated by the present disclosure.

The present disclosure contemplates that, in some embodiments, data used by AI/ML processes includes publicly available data. To protect user privacy, data may be anonymized, aggregated, and/or otherwise processed to remove or to the degree possible limit any individual identification. As discussed herein, entities that collect, share, and/or otherwise utilize such data should obtain user consent prior to and/or provide transparency when collecting such data. Furthermore, the present disclosure contemplates that the entities responsible for the use of data, including, but not limited to data used in association with AI/ML processes, should attempt to comply with well-established privacy policies and/or privacy practices.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

What is claimed:

1. An apparatus comprising processing circuitry configured to:
generate, for transmission to a serving cell, capability information comprising a list of models employing artificial intelligence (AI) or machine learning (ML) for beam management that are currently stored by a user equipment (UE), wherein each model is associated with first conditions for which the model is valid;
process, based on signals received from the serving cell, assistance information to adapt beam measurements for a first model stored by the UE to be used under second conditions different from the first conditions for which the first model is valid; and
adapt the beam measurements based on the assistance information to generate input data for the first model.

2. The apparatus of claim 1, wherein the assistance information allows the first model to be used for a beam sweeping process of a neighbor cell, the beam sweeping process of the neighbor cell being different from a beam sweeping process for which the first model is valid.

3. The apparatus of claim 1, wherein the conditions comprise a vendor, a cell site or a frequency band.

4. The apparatus of claim 1, wherein the assistance information comprises a mapping of a beam index for a beam sweeping process of a neighbor cell to a beam index for a beam sweeping process used to generate training data for the first model.

5. The apparatus of claim 4, wherein the beam sweeping process of the neighbor cell comprises a same codebook as the beam sweeping process used to generate the training data in a different spatial order.

6. An apparatus comprising processing circuitry configured to:
process, based on signals received from a user equipment (UE), capability information comprising a list of models employing artificial intelligence (AI) or machine learning (ML) for beam management that are currently stored by the UE, wherein each model is associated with conditions for which the model is valid;
process, based on signals received from a neighbor cell, transmit (Tx) beam information for a beam sweeping process of the neighbor cell;
determine, for a first model stored by the UE as indicated by the capability information, assistance information to adapt beam measurements for the first model to be used for the beam sweeping process of the neighbor cell, the beam sweeping process of the neighbor cell being different from a beam sweeping process for which the first model is valid; and
generate, for transmission to the UE, a message comprising the assistance information.

7. The apparatus of claim 6, wherein the conditions comprise a vendor, a cell site or a frequency band.

8. The apparatus of claim 6, wherein the assistance information comprises a mapping of a beam index for the beam sweeping process of a neighbor cell to a beam index for the beam sweeping process used to generate training data for the first model.

9. The apparatus of claim 8, wherein the beam sweeping process of the neighbor cell comprises a same codebook as the beam sweeping process used to generate the training data in a different spatial order.

10. An apparatus comprising processing circuitry configured to:
generate, for transmission to a serving cell, capability information comprising a list of models employing artificial intelligence (AI) or machine learning (ML) for beam management that are currently stored by a user equipment (UE), wherein each model is associated with first conditions for which the model is valid;
process, based on signals received from the serving cell, an instruction to refrain from using any of the AI/ML models currently stored by the UE;
process one of:
a firmware over the air (FOTA) update including a new model to be used under second conditions, different from the first conditions, for which one or more of the models currently stored by the UE are valid; or
new training data to retrain a first model to be used under the second conditions; and
generate, for transmission to the serving cell, updated capability information for the new model or the first model after retraining.

11. The apparatus of claim 10, wherein the new model or the first model after retraining is used for a beam sweeping process of a neighbor cell.

12. The apparatus of claim 10, wherein the processing circuitry is further configured to:
refresh the list of models after a timer duration;
keep one or more models corresponding to a beam sweeping process of most recently visited neighbor cells; and
discard one or more models corresponding to a beam sweeping process of neighbor cells that were not most recently visited.

13. The apparatus of claim 10, wherein the processing circuitry is further configured to:
process an instruction to initiate new training for the first model stored by the UE.

14. The apparatus of claim 13, wherein the processing circuitry is further configured to:
process the new training data comprising beam measurements acquired under the second conditions; and
retrain the first model based on the new training data.

15. The apparatus of claim 10, wherein the processing circuitry is further configured to:
generate, for transmission to the serving cell, an updated capability report.
